(19) United States
(12) Patent Application Publication
(10) Pub. No.: US 2025/0131262 A1
(43) Pub. Date: Apr. 24, 2025

(54) PERSONALIZED MACHINE LEARNING MODEL ADAPTERS

(71) Applicant: QUALCOMM Incorporated, San Diego, CA (US)

(72) Inventors: Jihwan BANG, Seoul (KR); Kyu Woong HWANG, Daejeon (KR); Simyung CHANG, Suwon (KR); Juntae LEE, Seoul (KR); Kyuhong SHIM, Seoul (KR); Seunghan YANG, Incheon (KR); Eunji KIM, Seoul-si (KR)

(21) Appl. No.: 18/493,286

(22) Filed: Oct. 24, 2023

(51) Int. Cl. G06N 3/08

(52) U.S. Cl. CPC G06N 3/08

(57) ABSTRACT

Certain aspects of the present disclosure provide techniques and apparatus for improved machine learning. A machine learning model is accessed. And an enrollment dataset for a device is accessed. A personalized model adapter generated based on the enrollment dataset and a plurality of model adapters is accessed. An input to the machine learning model is processed using the machine learning model in conjunction with the personalized model adapter. An output is provided, by the device, based on the processing.

### INTRODUCTION

Aspects of the present disclosure relate to machine learning.

A wide variety of machine learning architectures have recently been used to perform innumerable tasks with high accuracy and reliability. For example, computer vision models have been used to perform tasks such as object detection and distance prediction. As another example, language models (e.g., large language models (LLMs)) have been used to understand and generate textual output in a human-like fashion, such as for use in chat bots. However, many existing model architectures are large (e.g., having thousands or millions of parameters), and training such models generally relies on vast amounts of training data (and incurs similarly vast computational expense).

### BRIEF SUMMARY

Certain aspects of the present disclosure provide a processor-implemented method, comprising: accessing a machine learning model; accessing an enrollment dataset for the device; accessing a personalized model adapter generated based on the enrollment dataset and a plurality of model adapters; processing an input to the machine learning model using the machine learning model in conjunction with the personalized model adapter; and providing an output, by the device, based on the processing.

Certain aspects of the present disclosure provide a processor-implemented method, comprising: accessing a machine learning model; generating a plurality of model adapters for the machine learning model based on at least one training dataset; accessing an enrollment dataset for a device; generating a personalized model adapter based on the enrollment dataset and the plurality of model adapters; and deploying the personalized model adapter for the device.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for generating personalized model adapters, according to some aspects of the present disclosure.

FIG. 2 is a flow diagram depicting an example method for generating personalized model adapters based on a pool of model adapters, according to some aspects of the present disclosure.

FIG. 3 is a flow diagram depicting an example method for generating adapter keys, according to some aspects of the present disclosure.

FIG. 4 is a flow diagram depicting an example method for generating a pool of model adapters, according to some aspects of the present disclosure.

FIG. 5 is a flow diagram depicting an example method for generating personalized model adapters based on enrollment data, according to some aspects of the present disclosure.

FIG. 6 is a flow diagram depicting an example method for generating model output based on a personalized model adapter, according to some aspects of the present disclosure.

FIG. 7 is a flow diagram depicting an example method for generating a personalized model adapter, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved personalized machine learning model adapters.

In some aspects, a pool of model adapters can be trained for a machine learning model, and these model adapters can be sampled or mixed to generate a personalized model adapter for individual users or tasks based on enrollment data for the user or task. Advantageously, in some aspects, non-personalized model adapters (e.g., generated based on various datasets that are not specific to an individual user) are trained, and personal enrollment data (specific to a given user) is used to mix these adapters, rather than to train or fine-tune an adapter. That is, rather than attempting to train an adapter based on an individual user's data (which often fails to produce adequate results due to insufficient amounts of personal enrollment data), pre-trained adapters can be mixed using a substantially smaller set of enrollment data. This enables generation of personalized model adapters using reduced amounts of data, as well as significantly reduced computational expense.

In some aspects, a base or core machine learning model (e.g., an LLM) may be used to generate or train a set of model adapters, such as using parameter-efficient fine-tuning (PEFT). In some aspects, one or more general datasets (e.g., data not associated with a specific user) can be used to train the model adapters. In some aspects, a set of task-specific datasets may be used to train task-specific adapters. Generally, a “task” may refer to the problem and/or solution domain that is desired to be solved. For example, one task may relate to mathematics (e.g., an adapter trained specifically to provide improved output for questions that relate to mathematics), while a second task relates to European history (e.g., an adapter trained specifically to provide improved output for questions related to European history), and so on.

In some aspects, these model adapters (which may be task-specific) can then be mixed or merged based on a user's personal enrollment data in order to generate a personalized adapter. For example, in some aspects, the enrollment data can be processed using the base machine learning model to generate a set of embeddings (e.g., one for each layer of the model). These embeddings (also referred to as embedding tensors and/or layer features in some aspects) may then be compared against adapter-specific keys or coefficients, as discussed in more detail below, to generate an adapter mixer tensor. In some aspects, the adapter mixer tensor comprises, for each layer in the base model, a set of adapter weights. These weights can then be used to compute, for each layer, a weighted linear sum of the parameters in the corresponding layer of each adapter. As a result, the personalized adapter mixes the parameters of the pool of adapters on a per-layer basis based on the enrollment data, allowing the personalized model adapter to become highly personalized without requiring additional training or fine-tuning of any parameters.

### Example Workflow for Generating Personalized Model Adapters

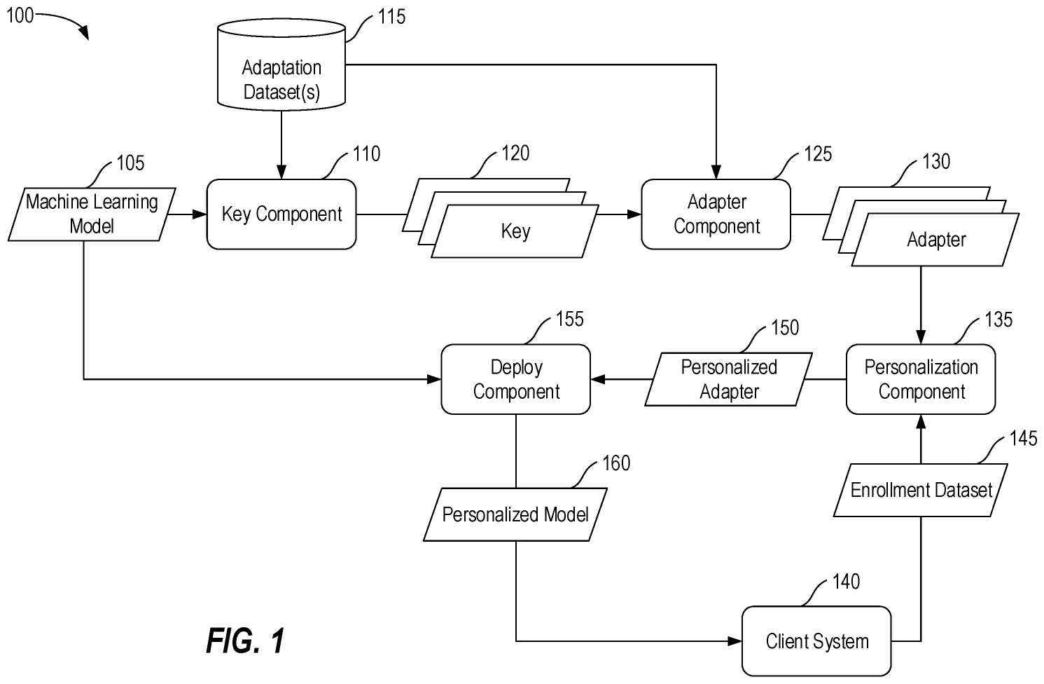

FIG. 1 depicts an example workflow 100 for generating personalized model adapters, according to some aspects of the present disclosure. In some aspects, the workflow 100 is performed by a computing system, such as a machine learning system. That is, the depicted elements may be components of a machine learning system, which may be implemented using one or more physical and/or virtual computing systems.

In the illustrated example, a machine learning model 105 (referred to in some aspects as a base model or core model) is accessed by a key component 110. As used herein, “accessing” data generally includes receiving, requesting, retrieving, generating, collecting, or otherwise obtaining access to the data. In some aspects, the machine learning model 105 is a pre-trained model (e.g., a model having parameters learned or trained by another system or component). In some aspects, the key component 110 (or another component of the machine learning system) trains the machine learning model 105. The machine learning model 105 may generally use any architecture and design. The machine learning model 105 may be trained for any suitable task. In some aspects, for example, the machine learning model 105 generates textual output based on textual inputs. For example, the machine learning model 105 may be trained to generate natural language output in response to natural language input from users. In some aspects, the machine learning model 105 is a language model (e.g., an LLM).

In some aspects, the machine learning model 105 may be a relatively general model. For example, the machine learning model 105 may be trained to generate text responses generally for any topic or task. In some aspects, to improve model performance on more specific tasks or topics, model adapters may be trained as discussed in more detail below.

In the illustrated workflow, the key component 110 also accesses a set of one or more adaptation datasets 115 (also referred to in some aspects as training datasets). In some aspects, the adaptation datasets 115 comprise training data (e.g., sample input text, also referred to as a sample prompt and/or as a sample query in some aspects, with corresponding output response text) for one or more specific tasks or topics. For example, a first adaptation dataset 115 may correspond to a “European History” topic (e.g., including example request and response text for discussions related to European history), while a second adaptation dataset 115 corresponds to a “Mathematics” topic (e.g., including example request and response text for discussions related to math).

In the illustrated example, the key component 110 uses the adaptation datasets 115 and the machine learning model 105 to generate a set of keys 120 (also referred to in some aspects as adapter coefficients). In some aspects, the keys 120 are task specific. For example, if a given adaptation dataset 115 corresponds to a given task or topic, the key component 110 may generate a corresponding key 120 for the given task or topic using exemplars in the given adaptation dataset 115.

In some aspects, to generate the keys 120, the key component 110 processes exemplars from the adaptation datasets 115 using the machine learning model 105. In some aspects, each key 120 corresponds to a tensor or vector having a value or element for each respective layer in the machine learning model 105. For example, if the machine learning model 105 has N layers, the keys 120 may each be an N-element vector, where each respective element corresponds to a respective layer in the machine learning model 105. In some aspects, the value of the key 120 for a given layer is generated based on embeddings (also referred to as features in some aspects) that are generated by the given layer when one or more exemplars in the adaptation datasets 115 are processed using the machine learning model 105.

For example, for a set of exemplars (e.g., samples in a given adaptation dataset 115), the key component 110 may process each sample in the set using the machine learning model 105 to generate a set of embeddings for each layer. The embeddings with respect to each given layer may then be aggregated (e.g., summed, averaged, weighted, etc.) to generate a representative value for the given layer, with respect to the set of exemplars. This value is then used as a key value for the layer (e.g., an element in a key 120 that corresponds to the adaptation dataset 115).

In some aspects, the key component 110 generates or defines the keys 120 using Equation 1 below, where kⱼ^{L} is the value of a key 120 that corresponds to the j-th dataset (e.g., a specific adaptation dataset 115) with respect to the L-th layer of the machine learning model 105, x is the j-th adaptation dataset 115, and oᵢ^{L} is the output of the L-th layer when the xᵢ-th exemplar from the j-th adaptation dataset 115 is processed using the machine learning model 105.

$${k}_{j}^{L} = \frac{1}{\vert x \vert} {\sum }_{i = 1}^{\vert x \vert} {o}_{i}^{L} \qquad ( 1 )$$

In this way, the key component 110 can generate a set of keys 120 (e.g., one for each adaptation dataset 115), where each key 120 comprises an aggregated embedding value for a corresponding layer of the machine learning model 105 based on the corresponding adaptation dataset 115. These keys 120 may then be used to train a set of adapters.

In some aspects, rather than generating task-specific keys 120 based on task-specific adaptation datasets 115, the key component 110 can use clustering (e.g., K-means clustering) to generate task-agnostic keys 120. For example, in some aspects, exemplars from one or more adaptation datasets 115 can be processed using the machine learning model 105 to generate a corresponding set of embeddings for each layer. In a clustering implementation, the key component 110 may cluster these embeddings (on a per-layer basis) using one or more clustering techniques or algorithms. A representative value for each cluster may then be used as a key 120 for a corresponding adapter. For example, for each cluster, the key component 110 may generate a key 120 by averaging the embeddings in the cluster, or by finding the cluster center. These task-agnostic keys 120 may then be used to train the set of adapters.

As illustrated, the keys 120 are accessed by an adapter component 125 which uses the keys 120, along with the adaptation datasets 115, to train or generate a set of adapters 130 (also referred to in some aspects as model adapters). In some aspects, as discussed above, each adapter 130 may have a corresponding key 120. That is, if the keys 120 are task specific (e.g., because each key 120 is generated based on a task-specific adaptation dataset 115), the adapters 130 may therefore also be referred to as task specific.

In some aspects, each of the adapters 130 has a smaller size than the base machine learning model 105 (e.g., fewer parameters and/or occupying less memory space). For example, in some aspects, each adapter 130 may be less than 1% of the size of the machine learning model 105, less than 2% of the size of the machine learning model 105, less than 5% of the size of the machine learning model 105, and so on.

In some aspects, the keys 120 are used to weight updates to each of the adapters 130 during training. In some aspects, the adapter component 125 uses the keys 120 to generate an adapter mixer tensor (also referred to as an adapter mixer value or simply as an adapter mixer in some aspects), and the adapter component 125 trains the adapters 130 based on the adapter mixer. In some aspects, the adapter component 125 generates a respective adapter mixer for each respective exemplar in the adaptation datasets 115 during training of the adapters 130. For example, the adapter component 125 may generate an adapter mixer for a given exemplar during the forward pass, and the adapter component 125 may use the adapter mixer to weight the updates to each adapter 130 during a backward pass for the exemplar.

In some aspects, the adapter mixer comprises, for each respective layer of the machine learning model 105, a respective set of mixer values or ratios (where each value of the set of mixer values corresponds to a respective adapter 130 from the pool of adapters). For example, for a given exemplar, the mixer value for a given adapter 130 in a given layer of the machine learning model 105 may be defined based on the similarity or distance between the key 120 that corresponds to the given adapter 130 and the embedding generated by the given layer of the machine learning model 105 based on the given exemplar. In some aspects, the adapter mixer is defined using Equation 2 below, where a^{L} is the adapter mixer for layer L, d(·) is a distance metric (e.g., cosine similarity), oᵢ^{L} is the embedding generated by layer L of the machine learning model 105 given input exemplar xᵢ (e.g., a sample from one of the adaptation datasets 115), and k_{N}^{L} is the value of the N-th key for the L-th layer.

$${a}^{L} = d ( {o}_{i}^{L} , [ {k}_{0}^{L} ; {k}_{1}^{L} ; … ; {k}_{N}^{L} ) \qquad ( 2 )$$

In some aspects, the adapter component 125 may normalize the adapter mixer, such as by applying a softmax operation with temperature. In some aspects, to update the parameters of each adapter 130 based on the given exemplar, the adapter component 125 may weight the gradients or update for each layer of each adapter 130 based on the corresponding value in the adapter mixer(s). This process can then be repeated for each exemplar in the adaptation datasets 115 to yield a set of trained adapters 130.

In some aspects, such as in the illustrated workflow, the adapters 130 are accessed by a personalization component 135. The personalization component 135 also accesses an enrollment dataset 145 (e.g., from a client system 140), and the personalization component 135 generates a personalized adapter 150 based on the enrollment dataset 145. In some aspects, client system 140 corresponds to a user device, such as (but not limited to) a smartphone, tablet, laptop or desktop computer, headset device, automobile, and/or the like. The enrollment dataset 145 generally corresponds to a representative or historical workload for the client system 140 and/or for a user of the client system 140. For instance, the enrollment dataset 145 may comprise or be based on the chat history of the user. For example, the chat history may be inputs (e.g., textual, verbal, etc.) that were previously provided by the user, such as while the user interacted with a chat system.

In some aspects, to generate the personalized adapter 150, the personalization component 135 evaluates the enrollment dataset 145 to generate a personalized embedding. For example, the personalized embedding may be defined using Equation 3 below, where eₚ^{L} is the personal embedding for layer L, Dₑₙ is the enrollment dataset 145, and oᵢ^{L} is the output embedding of the L-th layer of the machine learning model 105 when an input sample xᵢ is used as input to the model.

$${e}_{p}^{L} = \frac{1}{\vert {D}_{en} \vert} {\sum }_{i = 1}^{\vert {D}_{en} \vert} {o}_{i}^{L} \qquad ( 3 )$$

That is, the personalization component 135 may compute the mean embeddings for each layer of the machine learning model 105 when the samples in the enrollment dataset 145 are processed as input to the model.

In some aspects, the personalization component 135 can then generate a personalized adapter mixer tensor based on the personalized embedding and the keys 120. For example, the personal adapter mixer may be generated based on the distance or similarity between the personal embeddings and the keys 120. In some aspects, the personalization component 135 generates the personal adapter mixer using Equation 4 below, where aₚ^{L} is the personal adapter mixer for the L-th layer and d(·) is a distance metric (e.g., cosine similarity).

$${a}_{p}^{L} = d ( {e}_{p}^{L} , [ {k}_{0}^{L} ; {k}_{1}^{L} ; … ; {k}_{N}^{L} ) \qquad ( 4 )$$

In some aspects, the personalized adapter 150 can then be generated based on the personalized adapter mixer aₚ and the pool of adapters 130. For example, the personalization component 135 may aggregate the parameters of the adapters 130 based on the personalized adapter mixer (e.g., computing a weighted linear sum of the parameters in each layer). In some aspects, the personalized adapter 150 may be defined using Equation 5 below, where wₚ^{L} is the weights of the L-th layer of the personalized adapter 150, aᵢ^{L} is the value of the personalized adapter mixer for the L-th layer of the i-th adapter 130, and wᵢ^{L} is the weights of the L-th layer of the i-th adapter 130.

$${w}_{p}^{L} = {\sum }_{i = 1}^{N} {a}_{i}^{L} * {w}_{i}^{L} \qquad ( 5 )$$

That is, for each layer, the personalization component 135 may compute a weighted linear sum of parameters in the adapters 130 based on the personalized adapter mixer.

In the illustrated example, the personalized adapter 150 is then accessed by a deploy component 155, which also has access to the machine learning model 105. The deploy component 155 generates a personalized model 160 based on the machine learning model 105 and the personalized adapter 150. In some aspects, the personalized model 160 includes the machine learning model 105 and the personalized adapter 150 as separate components. For example, the client system 140 may generate output using the personalized model 160 by processing data using both the machine learning model 105 and the personalized adapter 150.

In other aspects, the deploy component 155 may optionally merge the personalized adapter 150 with the machine learning model 105 to generate the personalized model 160. For example, the deploy component 155 may, for each layer of the models, sum the corresponding weights of the personalized adapter 150 with the corresponding weights of the machine learning model 105 to yield the personalized model 160. In some aspects, the parameters (e.g., weights) of the machine learning model 105 with respect to a given layer may be represented as a tensor W having dimensionality M×N, and the parameters (e.g., weights) of the corresponding layer in the personalized adapter 150 may be represented as tensors wₐ and w_{b}, having dimensionality M×R and R×N, respectively. Therefore, the parameters of the machine learning model 105 and personalized model adapter 150 may be merged by computing W_{merged}=W+wₐ*w_{b}. This may allow the personalized model 160 to be used to generate personalized output without adding additional compute or memory burden to inferencing systems.

In the depicted workflow 100, the deploy component 155 can then deploy the personalized model 160 to the client system 140. For example, the deploy component 155 may transmit the parameters of the personalized model 160 to the client system 140. The client system 140 can then use the personalized model 160 to process input from the client system 140 and/or a user of the client system 140 to generate personalized output text.

In some aspects, the operations of the key component 110, adapter component 125, personalization component 135, and deploy component 155 are performed by the machine learning system. In some aspects, some or all of the operations may alternatively be performed by the client system 140. For example, in some aspects, the client system 140 receives the personalized adapter 150 and performs the operations of the deploy component 155. In some aspects, the client system 140 accesses the adapters 130 and further performs the operations of the personalization component 135. In some aspects, the client system 140 receives the keys 120 and further performs the operations of the adapter component 125. In some aspects, the client system 140 further performs the operations of the key component 110. Generally, each operation of the workflow 100 may be performed by any suitable computing system.

### Example Method for Generating Personalized Model Adapters Based on a Pool of Model Adapters

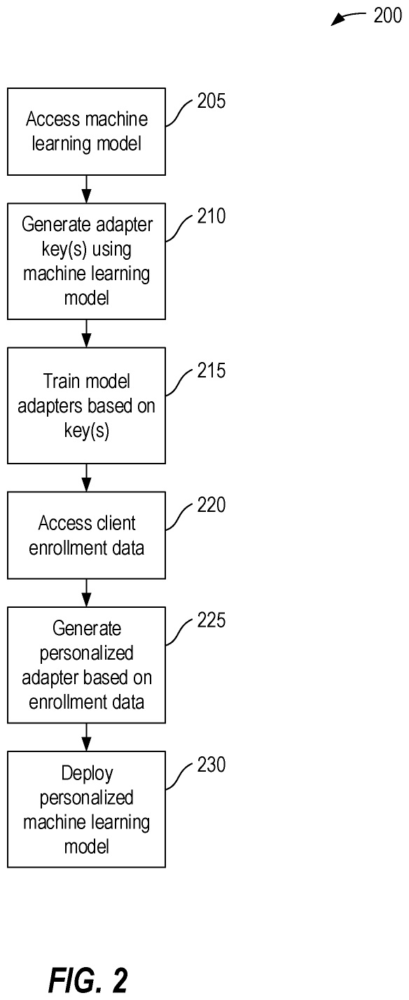

FIG. 2 is a flow diagram depicting an example method 200 for generating personalized model adapters based on a pool of model adapters, according to some aspects of the present disclosure. In some aspects, the method 200 is performed by a machine learning system and/or a client system, such as the machine learning system and/or client system 140 discussed above with reference to FIG. 1.

At block 205, the machine learning system accesses a trained machine learning model (e.g., the machine learning model 105 of FIG. 1). In some aspects, the machine learning model is a pre-trained language model (e.g., an LLM) that can be used to generate natural language output based on natural language input. In some aspects, the machine learning model is trained and/or provided by another system or entity. In other aspects, the machine learning model is trained by the machine learning system.

At block 210, the machine learning system generates a set of adapter keys (e.g., the keys 120 of FIG. 1) using the machine learning model. For example, as discussed above, the machine learning system may process exemplars from a task-specific adaptation dataset (e.g., an adaptation dataset 115 of FIG. 1) to generate a set of embeddings for each layer of the machine learning model, and aggregate (e.g., sum or average) the embeddings with respect to each layer. In this way, the machine learning system generates a key for each adapter. In some aspects, the machine learning system generates task-specific keys (to be used to train task-specific adapters) by using task-specific adaptation datasets. That is, the key for a given task may be generated based on exemplars from a given adaptation dataset that corresponds to the task.

In some aspects, the keys are task agnostic. For example, the adaptation datasets may not be task specific, and the machine learning system may generate a key for each adaptation dataset on a task-agnostic basis. For example, the machine learning system may cluster the embeddings generated by each layer and use a representative value for each cluster (e.g., the cluster center, or the average embedding value for the cluster) as a layer-specific adapter key for the cluster.

At block 215, the machine learning system trains one or more model adapters (e.g., the adapters 130 of FIG. 1) based on the adapter keys. In some aspects, as discussed above, the machine learning system may use the keys to generate, for each layer of the machine learning model/set of adapters, an adapter mixer. For example, the machine learning system may process an adaptation exemplar using the machine learning model to generate a set of embeddings (e.g., one for each layer of the model). The machine learning system may then compare the embedding for each layer with the layer-specific key value for each adapter (e.g., using cosine similarity) to generate the adapter mixer. This adapter mixer may then be used to weight updates to each adapter, as discussed above. In this way, each adapter learns more (e.g., the parameters are updated more) based on exemplars that are similar to the adapter's corresponding adapter key, as compared to exemplars that are less similar to the adapter key. If the keys are task-specific, this may cause each adapter to learn more for the adapter's corresponding task.

At block 220, the machine learning system accesses client enrollment data (e.g., the enrollment dataset 145 of FIG. 1). In some aspects, as discussed above, the client enrollment data corresponds to a representative or expected workload for a given user, application, or computing system. For example, the enrollment data may comprise historical chat records, such as one or more natural language inputs that the user (or application or system) previously provided to a chat system.

At block 225, the machine learning system generates a personalized adapter (e.g., the personalized adapter 150 of FIG. 1) based on the enrollment data. In some aspects, as discussed above, the machine learning system may generate a personalized embedding based on the enrollment data (e.g., a mean embedding value for each layer of the model, generated based on the exemplars in the enrollment data). This personalized embedding can then be used to generate a personalized adapter mixer (e.g., based on the distance between the personalized embedding and the adapter keys for each layer). In some aspects, as discussed above, the machine learning system may then aggregate the pool of adapters (trained at block 215) based on the personalized adapter mixer, such as by computing a weighted linear sum (e.g., a sum of the parameters in a given layer from each adapter, weighted based on the personalized adapter mixer values for the given layer).

At block 230, the machine learning system deploys a personalized machine learning model (e.g., the personalized machine learning model 160 of FIG. 1). For example, as discussed above, the machine learning system may transmit or otherwise provide the personalized adapter to a computing system that is used to generate responses for the user or entity corresponding to the enrollment data (e.g., to the client system 140 of FIG. 1). In some aspects, as discussed above, the machine learning system may optionally merge the personalized adapter with the base machine learning model, such as by summing the adapter weights with the model weights, prior to deployment.

As discussed above, the computing system may then use the personalized model to generate personalized model output, which may result in improved (e.g., more accurate or reliable) results, as compared to non-personalized models. Generally, to use the deployed model, the inferencing system (which may be the machine learning system or may be a different system) processes input to the model (e.g., natural language input, such as textual queries or requests from a user of the inferencing system) using the personalized machine learning model to generate corresponding output (e.g., natural language output, such as textual responses to the user's input request).

### Example Method for Generating Adapter Keys

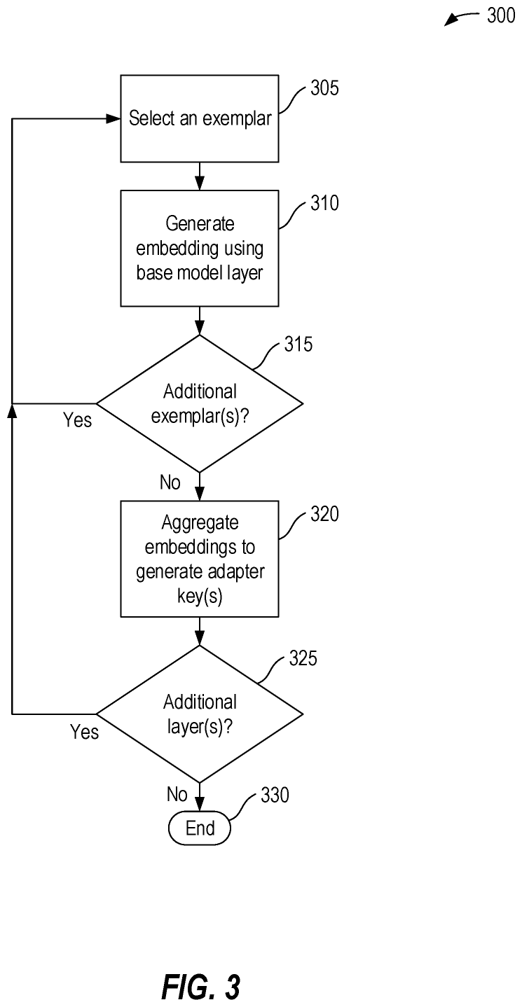

FIG. 3 is a flow diagram depicting an example method 300 for generating adapter keys, according to some aspects of the present disclosure. In some aspects, the method 300 is performed by a machine learning system and/or a client system, such as the machine learning system and/or client system 140 discussed above with reference to FIGS. 1-2. In some aspects, the method 300 provides additional detail for block 210 of FIG. 2.

In some aspects, the method 300 is performed for each adaptation dataset of a set of adaptation datasets (e.g., the adaptation datasets 115 of FIG. 1). That is, the method 300 may be used to generate, for each respective adaptation dataset, a respective key.

At block 305, the machine learning system selects an exemplar from an adaptation dataset. Generally, the machine learning system may use any suitable criteria to select the exemplar, including randomly or pseudo-randomly, as each exemplar in the application dataset may be processed during the method 300.

At block 310, the machine learning system generates an embedding (also referred to as a set of features in some aspects, as discussed above) based on processing the selected exemplar using at least a portion of the base machine learning model (e.g., by processing the exemplar up through a given layer of the base machine learning model. For example, as discussed above, if the layer is the first layer of the model, the machine learning system may process the exemplar using this layer to generate the embedding. In some aspects, if the layer is a subsequent layer (e.g., a hidden internal layer or an output layer), the machine learning system may process the exemplar using the first layer to generate an embedding, and process this embedding through each subsequent layer until the given layer is reached.

At block 315, the machine learning system determines whether there is at least one exemplar remaining in the adaptation dataset. If so, the method 300 returns to block 305. If not, the method 300 continues to block 320, where the machine learning system aggregates the embeddings for the layer to generate an adapter key for the layer. For example, as discussed above, the machine learning system may compute the average embedding for the layer, with respect to the adaptation dataset. In some aspects, such as for task-agnostic datasets, the machine learning system may cluster the embeddings for the layer and use these cluster centers (or other representative cluster values) to generate the adapter keys for the layer.

At block 325, the machine learning system determines whether there is at least one additional layer in the machine learning model. If so, the method 300 returns to block 305 to select an exemplar. The method 300 then continues to block 310 to generate embeddings for the next layer of the model. If no additional layers remain, at block 325, the method 300 terminates at block 330.

Although the illustrated example depicts an iterative process (e.g., processing each exemplar using a single layer before moving to the next layer) for conceptual clarity, in some aspects, the machine learning system may process some or all of the exemplars in parallel, and/or may process each exemplar using all layers of the model (to generate a set of embeddings) before selecting the next exemplar.

In these ways, the machine learning system generates a layer-specific key based on an adaptation dataset. In some aspects, as discussed above, the machine learning system may repeat the method 300 for multiple adaptation datasets in order to generate a set of keys (e.g., one for each adaptation dataset) that can be used to train a set of adapters. In some aspects, as discussed above, the adaptation datasets and keys are task specific. In other aspects, the adaptation datasets and keys may be task agnostic.

### Example Method for Generating a Pool of Model Adapters

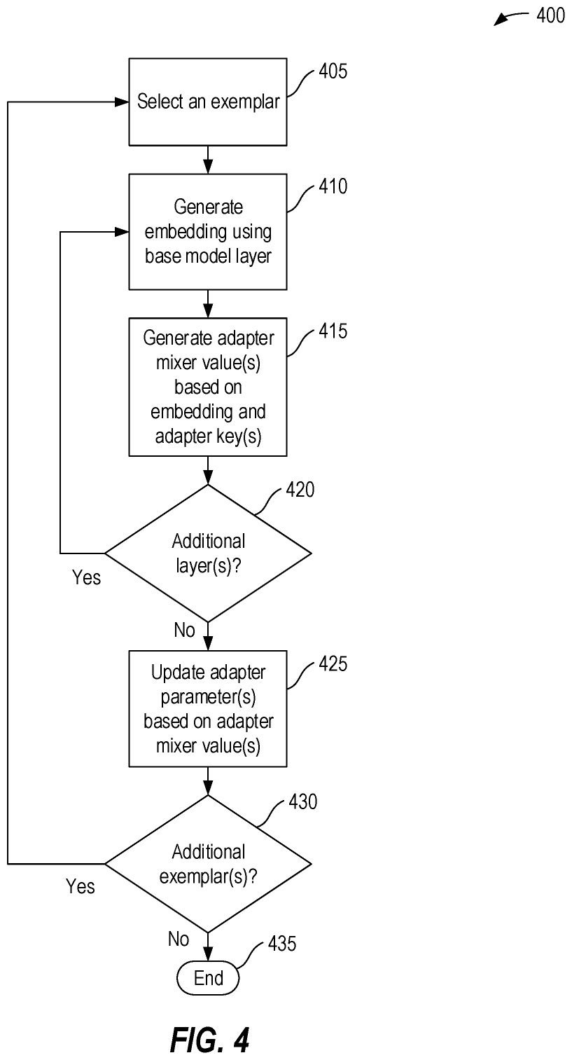

FIG. 4 is a flow diagram depicting an example method 400 for generating a pool of model adapters, according to some aspects of the present disclosure. In some aspects, the method 400 is performed by a machine learning system and/or a client system, such as the machine learning system and/or client system 140 discussed above with reference to FIGS. 1-3. In some aspects, the method 400 provides additional detail for block 215 of FIG. 2.

In some aspects, the method 400 is performed for each exemplar of the set of adaptation datasets. That is, the method 400 may be used to train a set of adapters based on each exemplar in any of the adaptation datasets.

At block 405, the machine learning system selects an exemplar from an adaptation dataset. Generally, the machine learning system may use any suitable criteria to select the exemplar, including randomly or pseudo-randomly, as each exemplar in the application datasets may be processed during the method 400.

At block 410, the machine learning system generates an embedding (also referred to as a set of features in some aspects, as discussed above) based on processing the selected exemplar using at least a portion of the base machine learning model (e.g., by processing the exemplar up through a given layer of the base machine learning model. For example, as discussed above, if the layer is the first layer of the model, the machine learning system may process the exemplar using this layer to generate the embedding. In some aspects, if the layer is a subsequent layer (e.g., a hidden internal layer or an output layer), the machine learning system may process the exemplar using the first layer to generate an embedding, and process this embedding through each subsequent layer until the given layer is reached.

At block 415, the machine learning system generates a set of adapter mixer values based on the generated embedding and the adapter keys, as discussed above. For example, the machine learning system may determine the distance or similarity between the embedding and each of the keys (with respect to the given layer used to generate the embedding), such as by computing the cosine similarity between the embedding and each key. In some aspects, as discussed above, these similarity measures may be used to define an adapter-specific weighting for the selected exemplar.

At block 420, the machine learning system determines whether there is at least one layer remaining in the machine learning model. If so, the method 400 returns to block 410 to generate another embedding and adapter mixer value for the next layer. If not, the method 400 continues to block 425.

At block 425, the machine learning system updates one or more adapter parameters of one or more adapters based on the adapter mixer values(s). For example, the machine learning system may determine an update to adapters based on the exemplar (e.g., by computing a loss based on the model output for the exemplar and a corresponding target output associated with the exemplar). This loss may then be used to generate updates (e.g., gradients) at each layer of the model.

In some aspects, during this adaptation phase, the parameters of the base machine learning model are frozen or unchanged. The machine learning system may use the update information to modify the parameters of the adapters, such as using backpropagation. In some aspects, at each layer of each adapter, the update (e.g., gradient) is weighted based on the adapter mixer value for the layer and adapter. In this way, different adapters may be updated differing amounts based on the same exemplar.

At block 430, the machine learning system determines whether there is at least one additional exemplar remaining. If so, the method 400 returns to block 405. If not, the method 400 terminates. Although the illustrated example depicts an iterative process (e.g., updating the adapters based on each exemplar individually, such as using stochastic gradient descent), in some aspects, the machine learning system may process some or all of the exemplars in parallel and/or in batches (e.g., updating the adapters using batch gradient descent).

In these ways, the machine learning system generates model adapters based on one or more adaptation datasets and adapter-specific keys.

### Example Method for Generating Personalized Model Adapters Based on Enrollment Data

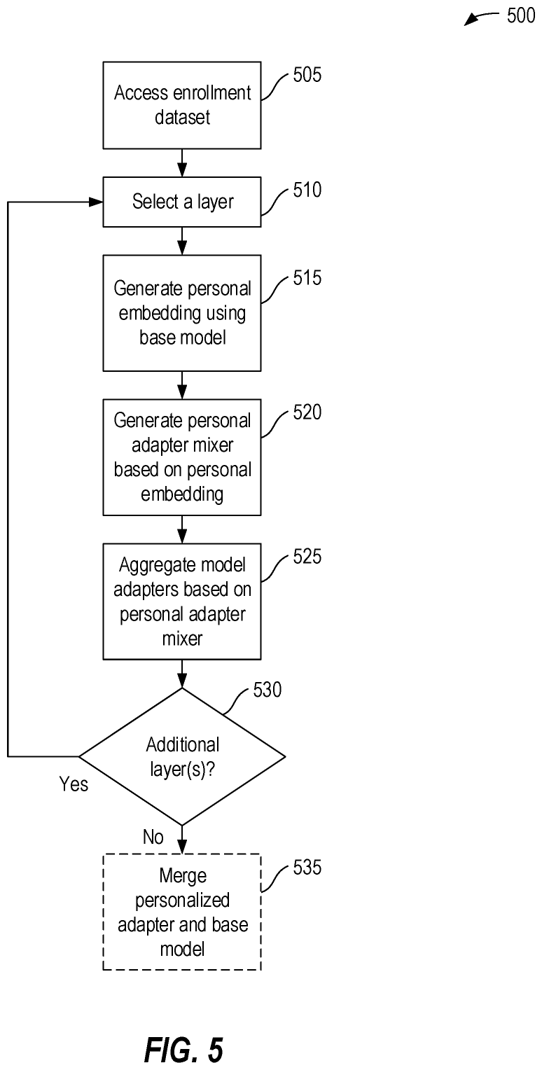

FIG. 5 is a flow diagram depicting an example method 500 for generating personalized model adapters based on enrollment data, according to some aspects of the present disclosure. In some aspects, the method 500 is performed by a machine learning system and/or a client system, such as the machine learning system and/or client system 140 discussed above with reference to FIGS. 1-4. In some aspects, the method 500 provides additional detail for block 225 of FIG. 2.

At block 505, the machine learning system accesses an enrollment dataset (e.g., the enrollment dataset 145 of FIG. 1). In some aspects, as discussed above, the enrollment dataset comprises or indicates a representative or expected workload for an entity (e.g., a user or application) that will use the personalized model. For example, the enrollment dataset may include chat logs of the user (e.g., historical queries from the user).

At block 510, the machine learning system selects a layer of the machine learning model. In some aspects, the machine learning system selects the layers sequentially (e.g., beginning with the input layer and moving towards the output layer).

At block 515, the machine learning system generates a personal embedding using the selected layer of the base model. For example, as discussed above, the machine learning system may process each exemplar in the enrollment dataset using the model (beginning with the input layer and proceeding through the selected layer) to generate an embedding (also referred to as a set of features, as discussed above). The embeddings generated for each exemplar in the enrollment dataset may then be aggregated, such as via summation or averaging (e.g., to generate the mean embedding of the enrollment data with respect to the selected layer).

At block 520, the machine learning system generates a personal adapter mixer for the selected layer based on the personal embedding. For example, as discussed above, the machine learning system may determine the difference (e.g., the cosine distance) between the personal embedding and the layer-specific value for each key with respect to the selected layer.

At block 525, the machine learning system aggregates the model adapters based on the personal adapter mixer. In some aspects, as discussed above, the machine learning system may compute a linear sum of the parameters from each adapter, weighted based on the personal adapter mixer. That is, the machine learning system may generate parameters for the selected layer of the personalized adapter by weighting and summing the parameters of the selected layer with respect to each of the adapters.

At block 530, the machine learning system determines whether there is at least one additional layer. If so, the method 500 returns to block 510 to process the next layer. If not, the method 500 continues to block 535. Although depicted as an iterative process (e.g., processing each layer in turn) for conceptual clarity, in some aspects, the machine learning system may process some or all of the exemplars using some or all of the layers before generating the personalized model adapter.

At block 535, the machine learning system optionally merges the personalized adapter and the base machine learning model. For example, as discussed above, the machine learning system may sum or otherwise aggregate the personalized adapter parameters with the parameters of the base model.

In these ways, the machine learning system may generate a personalized model adapter based on enrollment data without actively training any models based on the data. That is, because the enrollment data is used to mix or aggregate pre-trained model adapters (rather than training a new adapter for the user), the personalized model adapter may be generated using substantially reduced computational resources (and relying on substantially fewer exemplars), as compared to some conventional approaches. That is, some conventional approaches rely on large amounts of personalization data, which substantially reduces (or even eliminates) the potential to personalize or adapt such models to specific tasks or users. Aspects of the present disclosure enable generation of such personalized adapters with substantially fewer resources.

### Example Method for Generating Model Output Based on a Personalized Model Adapter

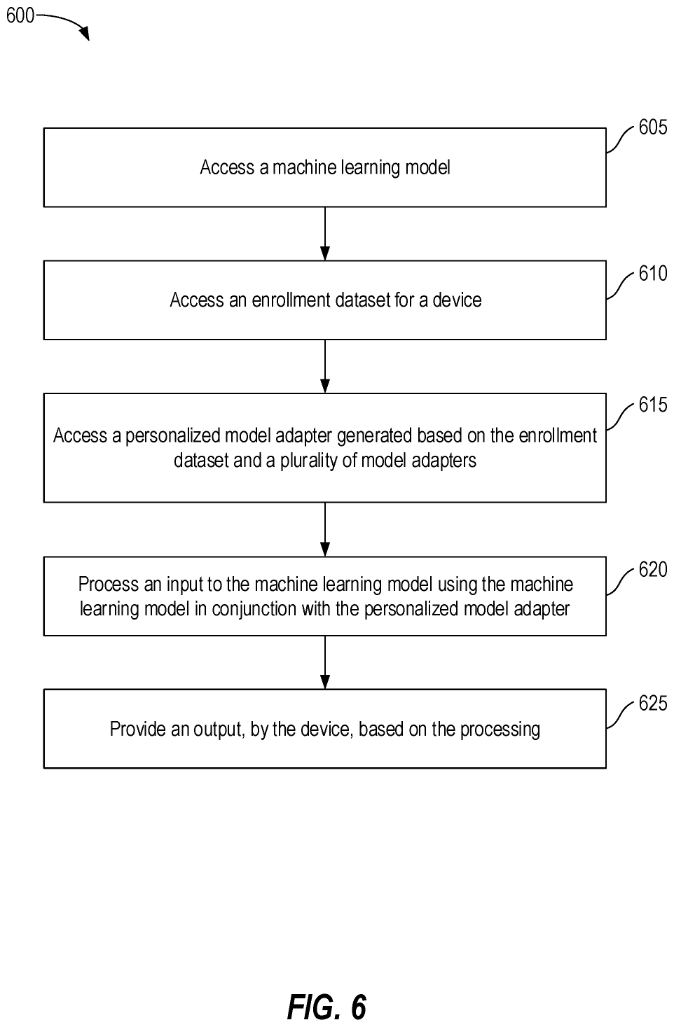

FIG. 6 is a flow diagram depicting an example method 600 for generating model output based on a personalized model adapter, according to some aspects of the present disclosure. In some aspects, the method 600 is performed by a machine learning system and/or a client system, such as the machine learning system and/or client system 140 discussed above with reference to FIGS. 1-5.

At block 605, a machine learning model is accessed.

At block 610, an enrollment dataset for a device (e.g., client system 140) is accessed. In some aspects, the method 600 is performed by the device. In some aspects, the method 600 is performed by a different device (distinct from the device associated with the enrollment dataset).

At block 615, a personalized model adapter generated based on the enrollment dataset and a plurality of model adapters is accessed.

In some aspects, the method 600 further includes generating an adapter mixer tensor based on the enrollment dataset and generating the personalized model adapter from the plurality of model adapters using the adapter mixer tensor.

In some aspects, generating the adapter mixer tensor comprises generating an embedding tensor based on processing the enrollment dataset using the machine learning model and generating the adapter mixer tensor based on the embedding tensor.

In some aspects, generating the adapter mixer tensor comprises, for each respective layer of a corresponding plurality of layers in the machine learning model, computing a similarity metric between a respective portion of the embedding tensor corresponding to the respective layer and a set of adapter keys for the respective layer.

In some aspects, generating the personalized model adapter comprises computing a weighted linear sum of parameters of the plurality of model adapters based on the adapter mixer tensor.

At block 620, an input (e.g., natural language text) to the machine learning model is processed using the machine learning model in conjunction with the personalized model adapter.

At block 625, an output (e.g., a natural language response to the input text) is provided, by the device, based on the processing.

In some aspects, the method 600 is performed on the device.

In some aspects, the method 600 further includes generating a merged machine learning model by adjusting parameters of the machine learning model using the personalized model adapter.

In some aspects, the machine learning model has a first size, the personalized model adapter has a second size, and the second size is smaller than the first size.

### Example Method for Generating a Personalized Model Adapter

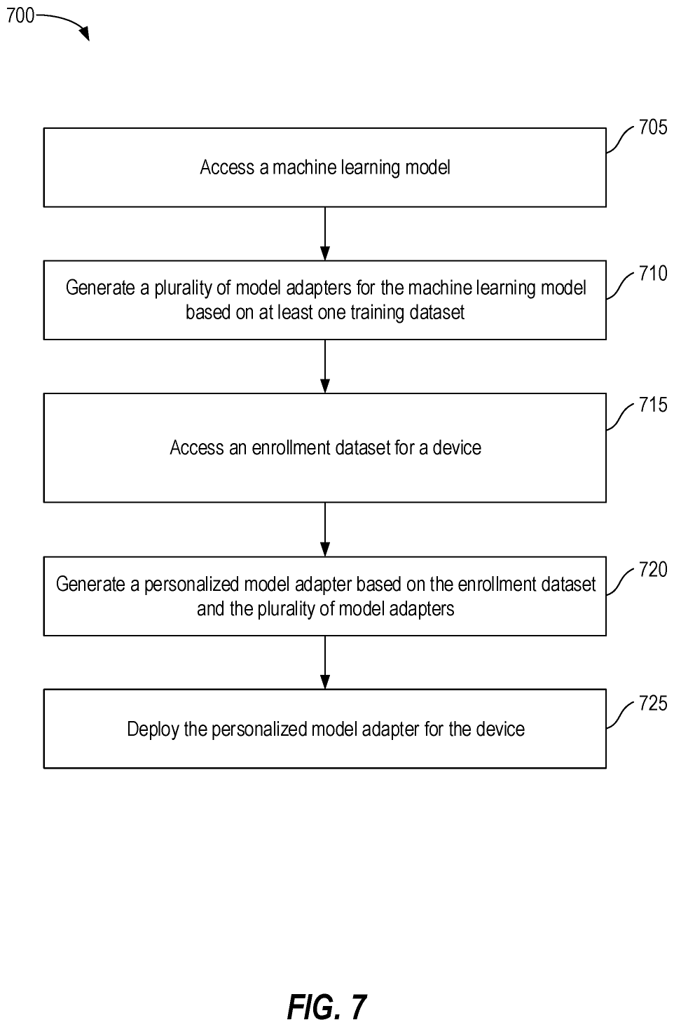

FIG. 7 is a flow diagram depicting an example method 700 for generating a personalized model adapter, according to some aspects of the present disclosure. In some aspects, the method 700 is performed by a machine learning system and/or a client system, such as the machine learning system and/or client system 140 discussed above with reference to FIGS. 1-6.

At block 705, a machine learning model is accessed.

At block 710, a plurality of model adapters for the machine learning model is generated based on at least one training dataset.

In some aspects, generating the plurality of model adapters comprises generating an adapter coefficient based on the at least one training dataset, generating a first embedding based on processing a first exemplar, from the at least one training dataset, using the machine learning model, generating a first adapter mixer value based on the adapter coefficient and the first embedding, and updating one or more parameters of a first model adapter, of the plurality of model adapters, based on the first adapter mixer value.

In some aspects, generating the adapter coefficient comprises generating a plurality of embeddings based on processing a set of exemplars from the at least one training dataset using the machine learning model and aggregating the plurality of embeddings.

In some aspects, aggregating the plurality of embeddings comprises clustering the plurality of embeddings to generate at least a first cluster, and generating the adapter coefficient further comprises determining a representative value of the first cluster.

In some aspects, generating the first adapter mixer value comprises computing a similarity metric between the adapter coefficient and the first embedding.

In some aspects, updating the one or more parameters of the first model adapter comprises weighting gradients, generated based on the first embedding, using the first adapter mixer value.

In some aspects, the first adapter mixer value corresponds to a first layer of a plurality of layers of the machine learning model, and generating the plurality of model adapters further comprises generating a second adapter mixer value, for a second layer of the plurality of layers, based on the first embedding.

At block 715, an enrollment dataset for a device (e.g., a client system 140) is accessed. In some aspects, the method 700 is performed by the device. In some aspects, the method 700 is performed by a different device (distinct from the device associated with the enrollment dataset).

At block 720, a personalized model adapter is generated based on the enrollment dataset and the plurality of model adapters.

In some aspects, generating the personalized model adapter comprises generating a personalized embedding based on processing the enrollment dataset using the machine learning model and generating a personalized adapter mixer based on the personalized embedding.

In some aspects, generating the personalized model adapter comprises computing a weighted linear sum of parameters of the plurality of model adapters based on the personalized adapter mixer.

At block 725, the personalized model adapter is deployed for the device.

In some aspects, the method 700 further includes generating a merged machine learning model by summing parameters of the machine learning model and parameters of the personalized model adapter.

### Example Processing System for Machine Learning

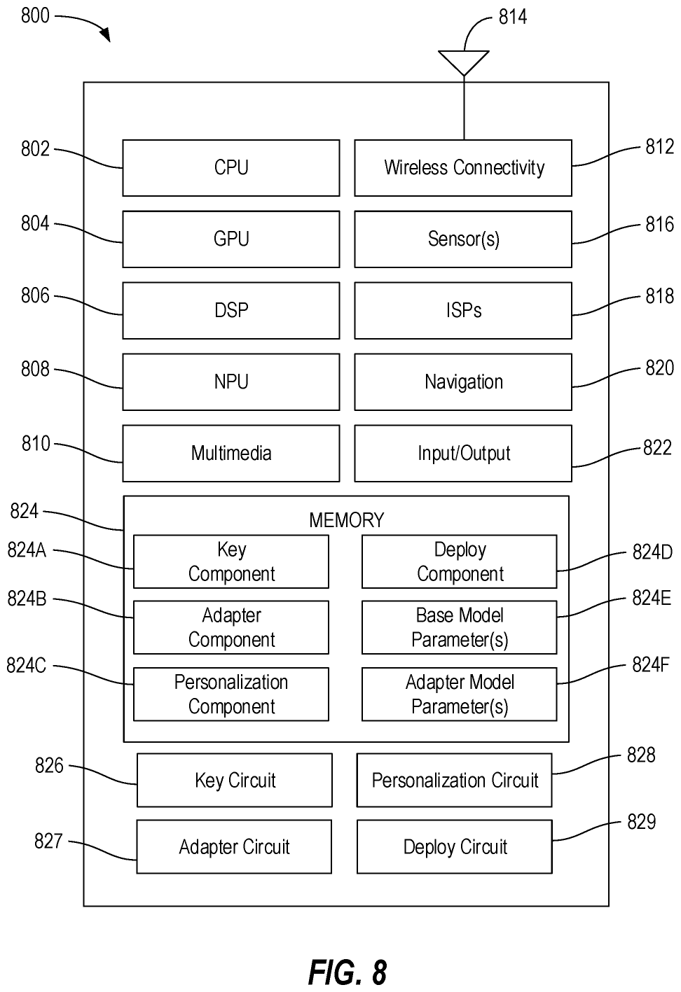

In some aspects, the workflows, techniques, and methods described with reference to FIGS. 1-7 may be implemented on one or more devices or systems. FIG. 8 depicts an example processing system 800 configured to perform various aspects of the present disclosure, including, for example, the techniques and methods described with respect to FIGS. 1-7. In some aspects, the processing system 800 may correspond to a machine learning system and/or a client system. For example, the processing system 800 may correspond to a device that generates adapter keys, trains model adapters, mixes model adapters to generate personalized adapters, and/or uses personalized adapters or models to generate output. Although depicted as a single system for conceptual clarity, in some aspects, as discussed above, the operations described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, GPU 804, and/or DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

Processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a key component 824A, an adapter component 824B, a personalization component 824C, a deploy component 824D, a set of base model parameters 824E (e.g., parameters of the machine learning model 105 of FIG. 1), and a set of adapter model parameters 824F (e.g., parameters of the adapters 130 of FIG. 1). Although not depicted in the illustrated example, the memory 824 may also include other data such as adaptation data (e.g., the adaptation datasets 115 of FIG. 1), enrollment data (e.g., the enrollment datasets 145 of FIG. 1), and the like. Though depicted as discrete components for conceptual clarity in FIG. 8, the illustrated components (and others not depicted) may be collectively or individually implemented in various aspects.

The processing system 800 further comprises a key circuit 826, an adapter circuit 827, a personalization circuit 828, and a deploy circuit 829. The depicted circuits, and others not depicted, may be configured to perform various aspects of the techniques described herein.

In some aspects, the key component 824A and/or key circuit 826 (which may correspond to the key component 110 of FIG. 1) may be used to generate adapter keys, as discussed above. For example, the key component 824A and/or key circuit 826 may generate task-specific or task-agnostic keys by processing adaptation data using the base machine learning model in order to generate or determine the average embedding for each layer (with respect to a given adaptation dataset). By determining the average embedding separately for each dataset, the key component 824A and/or key circuit 826 can generate dataset-specific keys (which can then be used to train dataset-tailored adapters).

In some aspects, the adapter component 824B and/or adapter circuit 827 (which may correspond to the adapter component 125 of FIG. 1) may be used to train model adapters, as discussed above. For example, the adapter component 824B and/or adapter circuit 827 may generate losses based on processing adaptation data using the base machine learning model, and update the parameters of each layer of each adapter based on the adapter keys (e.g., by weighting the updates). In these ways, the adapter component 824B and/or adapter circuit 827 can generate dataset-tailored adapters.

In some aspects, the personalization component 824C and/or personalization circuit 828 (which may correspond to the personalization component 135 of FIG. 1) may be used to generate a personalized model adapter, as discussed above. For example, the personalization component 824C and/or personalization circuit 828 may generate a personalized embedding based on enrollment data, and mix or aggregate the model adapters based on this embedding (e.g., based on the similarity between the personalized embedding and the key for each adapter). By mixing the adapter pool using the personal enrollment data, the personalization component 824C and/or personalization circuit 828 can generate personalized adapters without actually training any models or adapters.

In some aspects, the deploy component 824D and/or deploy circuit 829 (which may correspond to the deploy component 155 of FIG. 1) may be used to generate and/or deploy a personalized model (such as the personalized model 160 of FIG. 1), as discussed above. For example, the deploy component 824D and/or deploy circuit 829 may aggregate or merge the personalized adapter and the base model (such as by summing the parameters in each layer), as discussed above.

Though depicted as separate components and circuits for clarity in FIG. 8, the key circuit 826, adapter circuit 827, personalization circuit 828, and deploy circuit 829 may collectively or individually be implemented in other processing devices of the processing system 800, such as within the CPU 802, GPU 804, DSP 806, NPU 808, and the like.

Generally, the processing system 800 and/or components thereof may be configured to perform the methods described herein.

Notably, in other aspects, aspects of the processing system 800 may be omitted, such as where processing system 800 is a server computer or the like. For example, the multimedia component 810, wireless connectivity component 812, sensor processing units 816, ISPs 818, and/or navigation processor 820 may be omitted in other aspects. Further, aspects of the processing system 800 may be distributed between multiple devices.

### Example Clauses

Implementation examples are described in the following numbered clauses:

Clause 1: A method, comprising: accessing a machine learning model; accessing an enrollment dataset for a device; accessing a personalized model adapter generated based on the enrollment dataset and a plurality of model adapters; processing an input to the machine learning model using the machine learning model in conjunction with the personalized model adapter; and providing an output, by the device, based on the processing.

Clause 2: A method according to Clause 1, further comprising: generating an adapter mixer tensor based on the enrollment dataset; and generating the personalized model adapter from the plurality of model adapters using the adapter mixer tensor.

Clause 3: A method according to Clause 2, wherein generating the adapter mixer tensor comprises: generating an embedding tensor based on processing the enrollment dataset using the machine learning model; and generating the adapter mixer tensor based on the embedding tensor.

Clause 4: A method according to Clause 3, wherein generating the adapter mixer tensor comprises, for each respective layer of a corresponding plurality of layers in the machine learning model, computing a similarity metric between a respective portion of the embedding tensor corresponding to the respective layer and a set of adapter keys for the respective layer.

Clause 5: A method according to any of Clauses 2-4, wherein generating the personalized model adapter comprises computing a weighted linear sum of parameters of the plurality of model adapters based on the adapter mixer tensor.

Clause 6: A method according to any of Clauses 2-5, wherein the method is performed on the device.

Clause 7: A method according to any of Clauses 1-6, further comprising generating a merged machine learning model by adjusting parameters of the machine learning model using the personalized model adapter.

Clause 8: A method according to any of Clauses 1-7, wherein: the machine learning model has a first size; the personalized model adapter has a second size; and the second size is smaller than 1 percent of the first size.

Clause 9: A method, comprising: accessing a machine learning model; generating a plurality of model adapters for the machine learning model based on at least one training dataset; accessing an enrollment dataset for a device; generating a personalized model adapter based on the enrollment dataset and the plurality of model adapters; and deploying the personalized model adapter for the device.

Clause 10: A method according to Clause 9, wherein generating the plurality of model adapters comprises: generating an adapter coefficient based on the at least one training dataset; generating a first embedding based on processing a first exemplar, from the at least one training dataset, using the machine learning model; generating a first adapter mixer value based on the adapter coefficient and the first embedding; and updating one or more parameters of a first model adapter, of the plurality of model adapters, based on the first adapter mixer value.

Clause 11: A method according to Clause 10, wherein generating the adapter coefficient comprises: generating a plurality of embeddings based on processing a set of exemplars from the at least one training dataset using the machine learning model; and aggregating the plurality of embeddings.

Clause 12: A method according to Clause 11, wherein aggregating the plurality of embeddings comprises clustering the plurality of embeddings to generate at least a first cluster, and generating the adapter coefficient further comprises determining a representative value of the first cluster.

Clause 13: A method according to any of Clauses 10-12, wherein generating the first adapter mixer value comprises computing a similarity metric between the adapter coefficient and the first embedding.

Clause 14: A method according to any of Clauses 10-13, wherein updating the one or more parameters of the first model adapter comprises weighting gradients, generated based on the first embedding, using the first adapter mixer value.

Clause 15: A method according to any of Clauses 10-14, wherein: the first adapter mixer value corresponds to a first layer of a plurality of layers of the machine learning model; and generating the plurality of model adapters further comprises generating a second adapter mixer value, for a second layer of the plurality of layers, based on the first embedding.

Clause 16: A method according to any of Clauses 9-15, wherein generating the personalized model adapter comprises: generating a personalized embedding based on processing the enrollment dataset using the machine learning model; and generating a personalized adapter mixer based on the personalized embedding.

Clause 17: A method according to Clause 16, wherein generating the personalized model adapter comprises computing a weighted linear sum of parameters of the plurality of model adapters based on the personalized adapter mixer.

Clause 18: A method according to any of Clauses 9-17, further comprising generating a merged machine learning model by summing parameters of the machine learning model and parameters of the personalized model adapter.

Clause 19: A processing system comprising: a memory comprising computer-executable instructions; and one or more processors configured to execute the computer-executable instructions and cause the processing system to perform a method in accordance with any of Clauses 1-18.

Clause 20: A processing system comprising means for performing a method in accordance with any of Clauses 1-18.

Clause 21: A non-transitory computer-readable medium comprising computer-executable instructions that, when executed by one or more processors of a processing system, cause the processing system to perform a method in accordance with any of Clauses 1-18.

Clause 22: A computer program product embodied on a computer-readable storage medium comprising code for performing a method in accordance with any of Clauses 1-18.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access a machine learning model;
access an enrollment dataset for a device;
access a personalized model adapter generated based on the enrollment dataset and a plurality of model adapters;
process an input to the machine learning model using the machine learning model in conjunction with the personalized model adapter; and
provide an output, by the device, based on the processing.

2. The processing system of claim 1, wherein the one or more processors are configured to further execute the processor-executable instructions to cause the processing system to:
generate an adapter mixer tensor based on the enrollment dataset; and
generate the personalized model adapter from the plurality of model adapters using the adapter mixer tensor.

3. The processing system of claim 2, wherein, to generate the adapter mixer tensor, the one or more processors are configured to execute the processor-executable instructions to cause the processing system to:
generate an embedding tensor, wherein, to generate the embedding tensor, the one or more processors are configured to execute the processor-executable instructions to cause the processing system to process the enrollment dataset using the machine learning model; and
generate the adapter mixer tensor based on the embedding tensor.

4. The processing system of claim 3, wherein, to generate the adapter mixer tensor, the one or more processors are configured to execute the processor-executable instructions to cause the processing system to, for each respective layer of a corresponding plurality of layers in the machine learning model, compute a similarity metric between a respective portion of the embedding tensor corresponding to the respective layer and a set of adapter keys for the respective layer.

5. The processing system of claim 2, wherein, to generate the personalized model adapter, the one or more processors are configured to execute the processor-executable instructions to cause the processing system to compute a weighted linear sum of parameters of the plurality of model adapters based on the adapter mixer tensor.

6. The processing system of claim 2, wherein the processing system is the device.

7. The processing system of claim 1,
wherein the one or more processors are configured to further execute the processor-executable instructions to cause the processing system to generate a merged machine learning model; and
wherein, to generate the merged machine learning model, the one or more processors are configured to execute the processor-executable instructions to cause the processing system to adjust parameters of the machine learning model using the personalized model adapter.

8. A processor-implemented method for a device, comprising:
accessing a machine learning model;
accessing an enrollment dataset for the device;
accessing a personalized model adapter generated based on the enrollment dataset and a plurality of model adapters;
processing an input to the machine learning model using the machine learning model in conjunction with the personalized model adapter; and
providing an output, by the device, based on the processing.

9. The processor-implemented method of claim 8, further comprising:
generating an adapter mixer tensor based on the enrollment dataset; and
generating the personalized model adapter from the plurality of model adapters using the adapter mixer tensor.

10. The processor-implemented method of claim 9, wherein generating the adapter mixer tensor comprises:
generating an embedding tensor based on processing the enrollment dataset using the machine learning model; and
generating the adapter mixer tensor based on the embedding tensor.

11. The processor-implemented method of claim 10, wherein generating the adapter mixer tensor comprises, for each respective layer of a corresponding plurality of layers in the machine learning model, computing a similarity metric between a respective portion of the embedding tensor corresponding to the respective layer and a set of adapter keys for the respective layer.

12. The processor-implemented method of claim 9, wherein generating the personalized model adapter comprises computing a weighted linear sum of parameters of the plurality of model adapters based on the adapter mixer tensor.

13. The processor-implemented method of claim 9, wherein the method is performed on the device.

14. The processor-implemented method of claim 8, further comprising generating a merged machine learning model by adjusting parameters of the machine learning model using the personalized model adapter.

15. A processor-implemented method, comprising:
accessing a machine learning model;
generating a plurality of model adapters for the machine learning model based on at least one training dataset;
accessing an enrollment dataset for a device;
generating a personalized model adapter based on the enrollment dataset and the plurality of model adapters; and
deploying the personalized model adapter for the device.

16. The processor-implemented method of claim 15, wherein generating the plurality of model adapters comprises:
generating an adapter coefficient based on the at least one training dataset;
generating a first embedding based on processing a first exemplar, from the at least one training dataset, using the machine learning model;
generating a first adapter mixer value based on the adapter coefficient and the first embedding, comprising computing a similarity metric between the adapter coefficient and the first embedding; and
updating one or more parameters of a first model adapter, of the plurality of model adapters, based on the first adapter mixer value.

17. The processor-implemented method of claim 16, wherein generating the adapter coefficient comprises:
generating a plurality of embeddings based on processing a set of exemplars from the at least one training dataset using the machine learning model; and
aggregating the plurality of embeddings.

18. The processor-implemented method of claim 17, wherein:
aggregating the plurality of embeddings comprises clustering the plurality of embeddings to generate at least a first cluster, and
generating the adapter coefficient further comprises determining a representative value of the first cluster.

19. The processor-implemented method of claim 16, wherein updating the one or more parameters of the first model adapter comprises weighting gradients, generated based on the first embedding, using the first adapter mixer value.

20. The processor-implemented method of claim 15, wherein generating the personalized model adapter comprises:
generating a personalized embedding based on processing the enrollment dataset using the machine learning model; and
generating a personalized adapter mixer based on the personalized embedding based on computing a weighted linear sum of parameters of the plurality of model adapters based on the personalized adapter mixer.

21. A processing system, comprising:
one or more memories comprising processor-executable instructions; and
one or more processors configured to execute the processor-executable instructions and cause the processing system to:
access a machine learning model;
generate a plurality of model adapters for the machine learning model based on at least one training dataset;
access an enrollment dataset for a device;
generate a personalized model adapter based on the enrollment dataset and the plurality of model adapters; and
deploy the personalized model adapter for the device.

22. The processing system of claim 21, wherein, to generate the plurality of model adapters, the one or more processors configured to execute the processor-executable instructions and cause the processing system to:
generate an adapter coefficient based on the at least one training dataset;
generate a first embedding based on processing a first exemplar, from the at least one training dataset, using the machine learning model;
generate a first adapter mixer value based on the adapter coefficient and the first embedding; and
update one or more parameters of a first model adapter, of the plurality of model adapters, based on the first adapter mixer value.

23. The processing system of claim 22, wherein, to generate the adapter coefficient, the one or more processors configured to execute the processor-executable instructions and cause the processing system to:
generate a plurality of embeddings based on processing a set of exemplars from the at least one training dataset using the machine learning model; and
aggregate the plurality of embeddings.

24. The processing system of claim 23, wherein:
to aggregate the plurality of embeddings, the one or more processors configured to execute the processor-executable instructions and cause the processing system to cluster the plurality of embeddings to generate at least a first cluster, and
to generate the adapter coefficient, the one or more processors configured to further execute the processor-executable instructions and cause the processing system to determine a representative value of the first cluster.

25. The processing system of claim 22, wherein, to generate the first adapter mixer value, the one or more processors configured to execute the processor-executable instructions and cause the processing system to compute a similarity metric between the adapter coefficient and the first embedding.

26. The processing system of claim 22, wherein to update the one or more parameters of the first model adapter, the one or more processors configured to execute the processor-executable instructions and cause the processing system to weight gradients, generated based on the first embedding, using the first adapter mixer value.

27. The processing system of claim 22, wherein:
the first adapter mixer value corresponds to a first layer of a plurality of layers of the machine learning model; and
to generate the plurality of model adapters, the one or more processors configured to further execute the processor-executable instructions and cause the processing system to generate a second adapter mixer value, for a second layer of the plurality of layers, based on the first embedding.

28. The processing system of claim 21, wherein, to generate the personalized model adapter, the one or more processors configured to execute the processor-executable instructions and cause the processing system to:
generate a personalized embedding based on processing the enrollment dataset using the machine learning model; and
generate a personalized adapter mixer based on the personalized embedding.

29. The processing system of claim 28, wherein, to generate the personalized model adapter, the one or more processors configured to execute the processor-executable instructions and cause the processing system to compute a weighted linear sum of parameters of the plurality of model adapters based on the personalized adapter mixer.

30. The processing system of claim 21, wherein the one or more processors configured to execute the processor-executable instructions and cause the processing system to generate a merged machine learning model by summing parameters of the machine learning model and parameters of the personalized model adapter.
